(19) United States
(12) Patent Application Publication
(10) Pub. No.: US 2026/0069978 A1
(43) Pub. Date: Mar. 12, 2026

(54) SHUNTING A FIRST AUDIO SOURCE TO DISTINGUISH PRESENTATION OF A SECOND AUDIO SOURCE

(71) Applicant: Sony Interactive Entertainment Inc., Tokyo (JP)

(72) Inventor: Brandon Sangston, San Mateo, CA (US)

(21) Appl. No.: 18/882,653

(22) Filed: Sep. 11, 2024

(51) Int. Cl. A63F 13/54; G06F 40/166; G06F 40/58; G10L 19/008; G10L 19/02; H04S 3/00; H04S 7/00

(52) U.S. Cl. CPC A63F 13/54; G06F 40/58; G10L 19/008; G10L 19/0204; H04S 3/008; H04S 7/307; G06F 40/166; H04S 2400/01

(57) ABSTRACT

Methods and systems are disclosed for receiving in-game audio and non-game audio, and assigning a priority to each audio signal contained in the in-game audio and non-game audio. A specific audio signal identified from the in-game audio and the non-game audio is modified to generate a modified audio. The modified audio is forwarded with the unmodified audio to the user, such that the modified audio, when rendered, is distinguishably distinct from the unmodified audio.

### BACKGROUND OF THE INVENTION

### 1. Field of the Invention

The present disclosure relates to providing audio to a user during gameplay of a video game, and more specifically, adaptively selecting one of an in-game audio signal or an external audio signal to modify so that the audio signals presented to the user are rendered without conflict.

### 2. Description of the Related Art

Video gaming industry has grown in popularity and represents a large percentage of the entertainment market and interactive content generated worldwide. Various types of video games are available for playing. There are single-player video games and multi-player video games. In the case of multi-player video games, the users can play individually against one another or can be part of a team of users playing against at least one other second team. Further, the users of the multi-player video games can be co-located or remotely located from one another. A player can select a video game for game play and provide game inputs. The game inputs are used to affect a game state of the video game and to update game content. The updated game content includes game scenes that are returned to client device of the player for rendering. In the case of the multi-player video game, the game inputs of the different players are used to affect the game state and to synchronize the game content generated and returned to the client devices associated with the different players.

Generally speaking, the video game is associated with a number of audio signals. These audio signals are generated by the game logic or by the players interacting during gameplay of the video game. The audio signals associated with the video game include game audio (e.g., background music), audio generated in the game resulting from actions performed by one or more users, audio generated by player characters and/or non-player characters, audio generated from interaction between players within the game, to name a few. As the user continues to engage in the video game, the user can be exposed to other non-game related audio that are generated by other interactive applications that are running alongside the video game or received through communication channels to which the user is subscribed or has access. The other interactive applications that provide through communication channels can include chat applications, message applications, emails, social media applications, music applications, etc. In addition to the aforementioned audio, the user may also be exposed to other audio generated by or for the user or other users in the physical world in which the user is operating. Normally, the user, at any given time, is able to fully comprehend the audio from a single audio signal, be it the audio generated within the game (i.e., in-game audio) or audio generated by non-game applications (non-game audio) or the audio generated in the vicinity of the user in the physical world (other non-game audio). When more than one audio is rendering at the same time, such as an in-game audio and a non-game audio (e.g., an in-game conversation between players participating in the game and an external conversation between two users that are in the vicinity of the user playing the game), the user will be unable to fully comprehend both the conversations that are occurring simultaneously.

Typically, when the user is involved in gameplay, the in-game audio is streamed to the user so that the user can focus on what is occurring in the game, enabling the user to have a satisfactory gameplay experience. Since the in-game audio is presented to the user, it would result in the user missing out on the happenings occurring outside of the game. If the user wishes to be involved in the non-game audio occurring outside of the video game and/or in the physical world, the user will have to manually pause the game or shunt (e.g., blunt) the in-game audio, so that the user can fully comprehend the non-game audio.

It is in this context that embodiments of the invention arise.

### SUMMARY OF THE INVENTION

Implementations of the present disclosure relate to systems and methods for processing the various audio signals that are available for user consumption during game play of a video game to determine which audio signal to modify and which one to keep unaltered. The various audio signals that may be available to the user include in-game audio and non-game audio. The processing includes prioritizing the various audio signals and using the priorities to determine which audio signal to keep unaltered and which one to modify. The prioritizing can be done based on a current game context of the video game, the preferences specified for or by the user, and what is occurring in the physical world and/or non-game world. The priorities of the various audio signals are used to determine which one of an in-game audio or a non-game audio needs to be modified to amplify, blur, or enhance certain one of the audio signal. The modification can be done by adjusting audio characteristics of the one or more audio signal, wherein the characteristics that can be changed pertain to language, frequency, time of rendering, etc. The modification thus determines when and what (i.e., which audio signal) to modify, which ones to suppress or not send, and which communication channel to use for rendering the modified and/or unmodified audio signals for the user. Certain ones of the audio signals are modified/adjusted to ensure no conflicts exist between the modified audio signal and the unmodified audio signals, when rendered to the user. The rendering makes the modified audio signal distinguishable over the other audio signals.

The various implementations described herein are directed toward an adaptive audio system in which multiple channels of audio are being generated for presentation to the user. The adaptive audio system distinguishes between in-game audio of the video game currently being played by the user and non-game message content. Additional adjustments may be made to distinguish the different in-game audios and different non-game audios corresponding to different message content received from different content sources. For example, background music of the video game, audio generated by game character, audio generated by non-game character, audio generated by players during gameplay of the video game, audio generated in response to an action occurring in the video game, etc., can each be adjusted so that they can be rendered distinctly. The distinct rendering is made possible by modifying characteristics of select ones of the audio signals so that they have a higher/lower frequency, higher/lower volume, time shifted (i.e., for delayed rendering), or language adjusted, etc., to make the adjusted audio signal distinct from the other audio signals.

In some implementations, artificial intelligence (AI) is used to learn which part of the video game is important and which ones are not, which actions are related to significant events and which ones are not, which characters/players audio are important and which ones are not, behavior of the user to different audio signals, which non-game audio is important or preferred by the user and which ones are not, etc. The AI learnings are used to ensure that the audio signals associated with important parts of the game or important character interactions in the game or important sources are not modified (e.g., shunted). For example, an action that results in capturing or defeating a Boss in a Boss game is a significant event and the game audio generated when the Boss is captured is significant to boost the user's confidence in gameplay or to make the user feel good/accomplished. In another example, a team player's interaction with the user or with other members of the team in which the user is a member is important and are therefore not modified. The AI learnings are further used to personalize the modification of the audio signals for the user. For example, appropriate audio signals are identified and modifications customized in accordance to the user's preference or behavior. In some cases, priorities for the different audio signals can be set by the user. Consequently, the processing of the audio signals takes into consideration the AI learnt audio signal priorities and the user defined priorities/preferences to determine which audio signal to enhance, suppress, blunt, modify, delay, and which audio signals to maintain unmodified. The modified and unmodified audio signals are then communicated to different audio channels associated with the user for rendering to allow the user to not only have an enriching gameplay experience but also be aware of and react/enjoy non-game audio in a timely manner.

The adaptive audio system not only processes the in-game audio but also the non-game audio (including non-application external audio) and prioritizes the different audio signals based on the context of the game, the context of the non-game audio, the preferences of audio sources defined for and/or by the user to selectively modify select ones of the audio signals so that the different audio signals are rendered for the user without any conflict.

In one implementation, a method is disclosed. The method includes retrieving in-game audio from game content generated during gameplay of a video game. The game content is generated by applying game inputs provided by a user during the gameplay. The game content is used to determine current game state and current game context of the video game. Non-game audio generated during gameplay of the video game is received from one or more communication channels. Each of the in-game audio and non-game audio includes at least one audio signal. A priority is assigned to each audio signal included in the in-game audio and the non-game audio, based on the current game context of the video game and preference of the user. The priorities of the audio signals are used to identify a specific one of the audio signal that needs to be modified. The specific one of the audio signals identified from one of the in-game audio and the non-game audio, is modified to generate a modified audio, while remaining ones of the audio signals included in the in-game audio and the non-game audio are maintained as unmodified audio. The modified audio is forwarded with the unmodified audio for rendering at one or more audio channels associated with the user, such that the modified signal is distinguishably rendered over the unmodified audio.

In another implementation, a system for processing audio signals received by a user during gameplay of a video game, is disclosed. The system includes an audio shunting logic that is executed on a server of the system. The audio shunting logic is configured to, retrieve in-game audio from game content generated during gameplay of a video game, the game content generated by applying game inputs provided by a user during the gameplay, the game content used to determine a current game state and current game context of the video game; receive non-game audio generated during gameplay of the video game, the non-game audio received from one or more communication channels, wherein each of the in-game audio and the non-game audio includes at least one audio signal; assign a priority to each audio signal included in the in-game audio and the non-game audio, based on the current game context of the video game and preferences of the user, the priority used in identifying a specific one of the audio signal included in one of the in-game audio and the non-game audio that needs to be modified; modify the specific one of the audio signal identified from one of the in-game audio and the non-game audio to generate a modified audio while remaining ones of the audio signals included in the in-game audio and the non-game audio are maintained as unmodified audio; and forward the modified audio with the unmodified audio for rendering at one or more audio channels associated with the user, such that the modified audio is distinguishably rendered over the unmodified audio.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

The disclosure may be better understood by reference to the following description taken in conjunction with the accompanying drawings.

FIG. 1 represents a simplified block diagram of a cloud system that is used to process audio signals received by a user during gameplay of a video game, in accordance with one implementation.

FIG. 2 represents a simplified block diagram of a game console that engages an audio shunting logic to process audio signals generated for the user during gameplay of the video game, in accordance with an alternate implementation.

FIG. 3 identifies sub-modules of an audio shunting logic used for processing audio signals and forwarding modified audio with unmodified audio for rendering over different audio output channels, in accordance with one implementation.

FIG. 4 illustrates components of an example system that can be used to process audio signals generated for the user during gameplay of a video game, in accordance with one implementation.

### DETAILED DESCRIPTION

Broadly speaking, implementations of the present disclosure include an adaptive audio system and methods for identifying select one of an in-game and a non-game audio to modify so as to prevent the select one of the audio signals does not pose a conflict for other audio signals presented to the user during gameplay of a video game. The adaptive audio system engages an artificial intelligence (AI) model to learn the behavior of the user, current game context of the video game that is currently being played by the user, context of non-game audio generated by or for or in the vicinity of the user and presented to the user using one or more audio communication channels. Based on the learnings of the AI model, appropriate in-game audio or non-game audio is selected, modified and forwarded with other unmodified audio signal(s) to different audio communication channels engaged by the user, for rendering. The modification of select one of the audio signal ensures that the audio signals returned for rendering to the user are rendered without conflict.

With the general understanding of the disclosure, specific implementations of the disclosure will now be described in greater detail with reference to the various figures. It should be noted that various implementations of the present disclosure can be practiced without some or all of the specific details. In other instances, well known process operations have not been described in detail in order not to unnecessarily obscure various embodiments of the present disclosure.

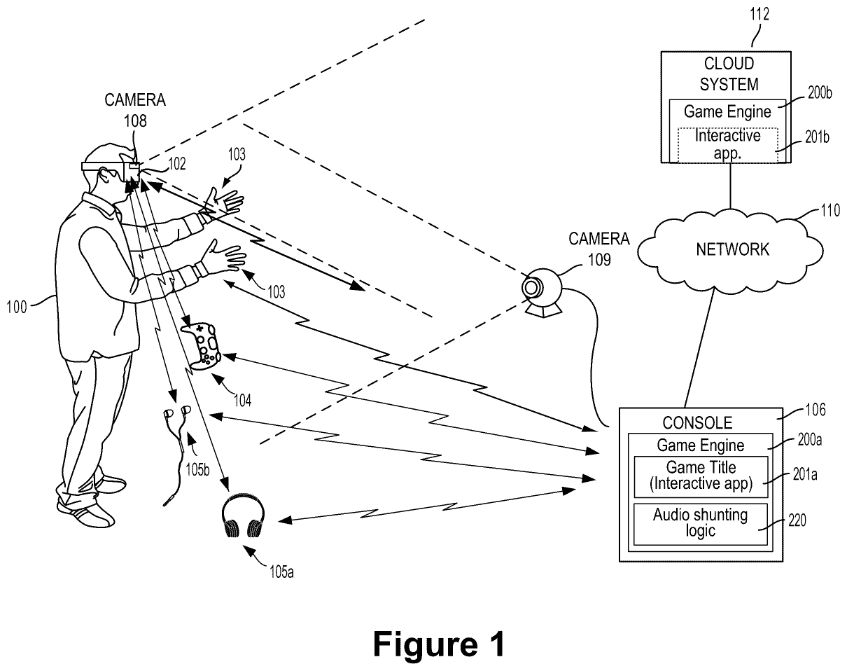

FIG. 1 represents a simplified block diagram of a system that is used for processing different audio signals and modifying one or more audio signals received during gameplay of a video game so as to distinguish the audio signals so that they do not conflict with one another when rendered to the user, in accordance with one implementation. The video game can be executing on a console 106, such as a game console (106), that is present locally in the user's physical environment. The game console 106 includes a game engine 200a and game logic associated with a game title 210a of the video game that the user has selected for gameplay. In some implementations, the game console 106 can store and execute a plurality of game titles (interactive applications) 201 using the game engine 200a. A plurality of input/output devices associated with the user are communicatively coupled to the game console 106 and used for providing inputs and receiving gameplay and audio content. The input/output devices can include wearable devices and hand-held or hand-operatable devices. Some of the wearable devices include a head mounted display (HMD) 102 worn on a head of the user 100 and includes input interfaces/controls for providing inputs and speakers for rendering audio, a headphone 105a or an earphone 105b, etc. The headphone 105a and earphone 105b include speakers for rendering audio. The hand-held or hand-operatable devices include a glove interface object 103, a controller 104, keyboard (not shown), touchpad (not shown), touchscreen (not shown), etc.

Each of the input devices (103, 104, 105a, 105b, etc. ,) are communicatively connected to the HMD 102. The HMD 102 and each of the input devices (103, 104, 105a, 105b, etc. ,) are also communicatively connected to the console (computing device) 106, and to the remote server of the cloud system 112 via the console 106 to enable communication between the various devices. The communication connection established between the various input/output devices and the console (i.e., computer) 106 as well as the communication connection between the console 106 and the remote server can be wired or wireless. The communication between the devices is to exchange content, provide inputs, and/or control actions or activities of one or more interactive applications (e.g., video game, other interactive applications, such as chat application, message application, email application, social media application, etc.), wherein interaction with the remote server is through a network 110, such as the Internet. The user can use any one of the input devices to interact with an interactive application (201) executing locally on the console 106 (e.g., video game executing on a game console), or remotely at the server of the cloud system 112.

In addition to the aforementioned input/output devices, one or more image capturing devices, such as an outward facing camera 108 mounted on an external surface of the HMD 102 or on the outside surface of other devices, such as the console 106, the controller 104, etc., and/or an external camera 109 that is disposed in the physical environment are used to track and capture images of the user and the physical environment of the user 100 as the user is interacting with the video game. In addition to the cameras 108, 109, one or more internal cameras (cameras disposed on inside surfaces of the HMD 102) (not shown), etc., may also be used to capture expressions of the user as the user is interacting with content of one or more interactive applications and used as inputs to the video game or other interactive applications that the user is interacting with or has access during gameplay of the video game.

The images of the user are captured by tracking the various wearable and user operable devices used by the user as the user is interacting in the physical environment. The tracking is done by capturing images of visual indicators, such as lights, tracking shapes, markers, etc., disposed on or associated with each of the input/output devices. The various wearable and user operable devices can also be tracked using embedded sensors in the respective devices. The images and/or sensor data pertaining to the various input/output devices (e.g., HMD 102, the glove interface object 103, the controller 104 (either a single-handed controller or a two-handed controller, the headphones 105a, earphones 105b, etc.) captured by the one or more cameras (108, 109, etc.) and/or sensors are used to determine the location, position, orientation, and/or movements of the user 100 in the physical environment as well as the inputs provided using the various input/output devices. The location of the user in the physical environment, for example, are provided as inputs to location-based interactive applications.

In some implementations, the console 106 is coupled to the remote server on the cloud system 112 over the network 110 to exchange gameplay information with the cloud system 112. In some implementations, a portion 201a of the video game is executed on the console 106 while the remaining portion 201b of the video game is executed on the cloud system 112, and the game input and the game content are synchronized between the console 106 and the cloud system 112. In alternate implementations, the video game is executed solely on one or more remote servers on the cloud system and the console acts as a “conduit” for exchanging the game input and the game content between the inputs devices, the console 106 and the one or more remote servers of the cloud system 112. The console 106 can be any general or special purpose computer known in the art, including but not limited to, a personal computer, laptop, tablet computer, mobile device, cellular phone, tablet, thin client, part of a set-top box, media streaming device, virtual computer, etc. The remote server that is part of cloud system 112 may be a cloud server within a data center of the cloud system 112. The data center can include a plurality of servers or consoles that provide the necessary resources to host one or more interactive applications 200b that can be accessed by the user over the network 110. In some implementations, an instance of the interactive application may be executing on one or more consoles (e.g., game consoles) or servers (e.g., game servers) distributed across multiple data centers and access to the instance executing on a console or server of a particular data center is provided based on geolocation of the user. The consoles may be independent consoles or may be rack-mounted server or a blade server. The blade server, in turn, may include a plurality of server blades with each blade having required circuitry and resources for instantiating a single instance of the interactive application, for example, to generate the necessary content data stream that is forwarded to the input/output devices associated with the user, for rendering, for example. The content data stream can be rendered on a display screen associated with the user 100 and communicatively connected to the console 106. Thus, the interactive application, such as video game 200a, can be executing solely on the local console 106, or a portion executing on the local console 106 and the remote server, or solely on the remote server, and the information related to gameplay of the video game is transmitted either directly to the local console 106 or to the remote server over the network 110.

In some implementations, an audio shunting logic 220 is communicatively connected to the game engine to exchange gameplay related information with the game logic of a video game that the user has selected for gameplay. The audio shunting logic 220 can be executing locally on the console (i.e., computer) 106, or remotely on a server in the cloud system, or can be executing both at the console 106 and the remote server. The audio shunting logic 220 is thus similar in design in that the audio shunting logic 220 can be exclusively executed on the console 106 or the remote server or can be executing at both the console 106 and the remote server at the cloud system 112. The audio shunting logic 220 is configured to receive the game content of the video game selected for gameplay by the user and retrieve in-game audio from the game content. The in-game audio can include game music, audio generated by player characters, non-player characters, or player interactions within a game scene, audio generated in response to an action, etc. The audio shunting logic 220 also receives non-game audio from different audio sources. The non-game audio is captured using microphones distributed in the different input/output devices or are provided by other interactive applications via one or more communication channels. The non-game audio can include any one or more of background music, conversations, voice memos, chat audio, audio from social media channels, etc. The audio shunting logic 220 analyzes the game content of the video game to determine a current game context, determine the context of other interactive applications providing non-game audio, context associated with the non-game audio generated in the physical world in the vicinity of the user, preferences of the user, behavior of the user, etc., to determine which audio signal to modify and which audio signal to maintain without modification. The modification to an audio signal is to make the audio signal distinct from other audio signals and can include shunting or blurring, enhancing, adjusting frequency, adjusting volume, converting to a user-selected or user-preferred language, transposing to a different voice, etc.

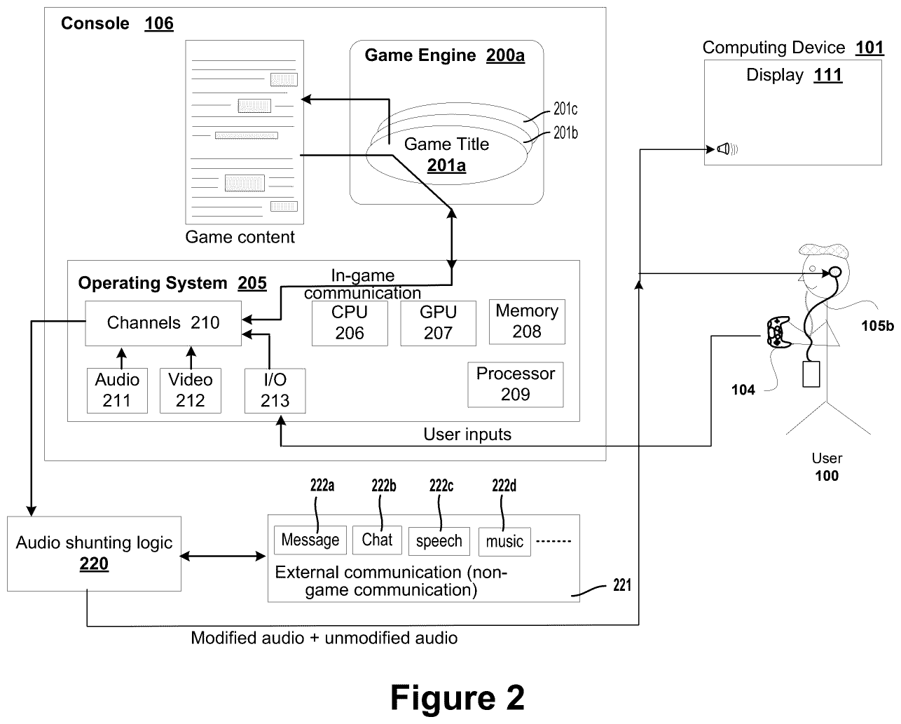

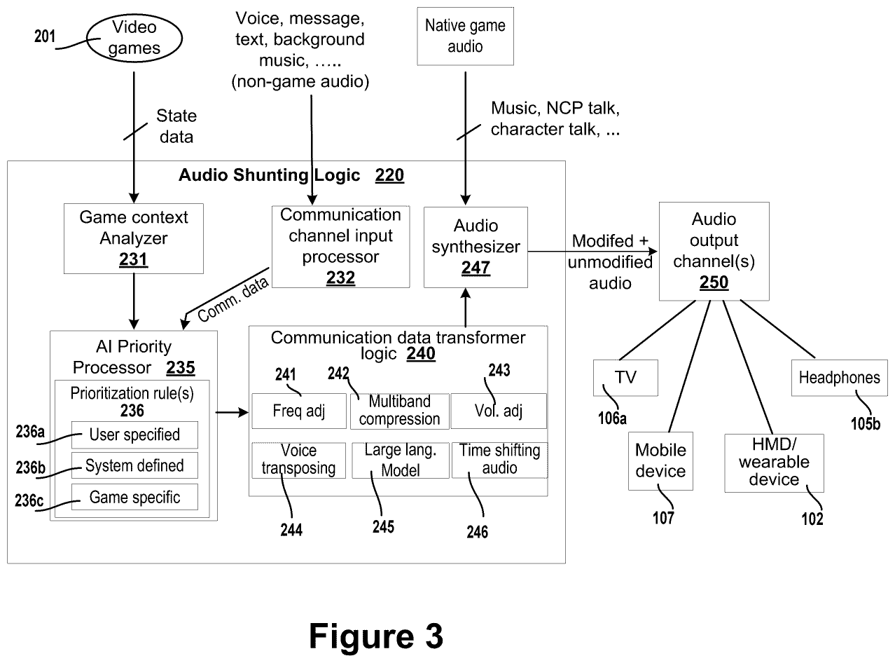

The modified audio signal and the unmodified audio signals are then forwarded to different communication channels for rendering. For example, audio from a chat application is directed to the headphone 105a or earphone 105b, the players interactions of the in-game audio is directed to the speaker of the HMD 102, game music of the video game is directed to the speaker of a television or display monitor/screen associated with the console (i.e., local computer) 106 that is used to render the game content of the video game, etc. In some implementations, a specific one of the audio signals is modified so that the audio associated with the modified audio signal can be heard distinctly over other audio signals. In alternate implementations, more than one audio signal can be modified. In such implementations, the modified audio signal may be shunted or blurred so that the audio associated with the unmodified audio signal can be heard distinctly over the modified audio signal. More details of the audio shunting logic will be discussed with reference to FIGS. 2 and 3.

FIG. 2 shows a computing system that is used to process various audio signals generated during gameplay of the video game by the user, so that selective ones of the audio signals can be modified so that the audio signals are distinctly rendered to the user, in some implementations. The processing of the audio signals includes identifying select ones of the audio signals to modify and select other ones to keep as unmodified. In some implementations, the modification is to enhance some of the audio characteristics of the select ones of the audio signals so that the modified audio signals can be rendered distinctly for the user. In alternate implementations, the modification is to shunt or blur some of the audio characteristics of the select ones of the audio signals so that the unmodified audio signals can be distinctly heard by the user.

The computing system includes a console 106, such as a game console that is equipped with a game engine 200a and a plurality of game titles 201, for user selection to gameplay. The game engine 200a provides the necessary gameplay resources and each of the game titles 201 include game logic that defines how the game is to be played. The computing system of a game engine 200a. A user 100 who is local to the game console 106 accesses the game console (also simply referred to as ‘console’) 106, and selects a game title 201 for gameplay. As noted with reference to FIG. 1, the user is associated with a plurality of devices used for interacting with the content generated during gameplay. Some of the plurality of devices associated with the user include a game controller (e.g., game controller operated with both hands of the user) 104 for providing interaction inputs, a pair of earphones 105b to render certain ones of the audio signals, a display 111 of a computing device 101 that is used to render game content and content of one or more interactive applications. The various input devices, the computing device 101, the display 111 of the computing device 101 are each communicatively connected to the console 106 so as to be able to exchange game content, game inputs, etc., during gameplay.

In response to the user selecting a game title 201 for gameplay, the game engine 200a executes the game logic associated with the game title 201. When the selected game title is executed by the game engine 200a, game scenes are generated. A game state and game scenes representing the game state are updated with user inputs provided through one or more input devices. The game engine uses the system utilities provided by the operating system 205 of the console 106, such as the central processing unit (CPU) 206, graphic processor unit (GPU) 207, memory 208 and processor 209 for executing the game. The system utilities also include various channels 210 for receiving and processing the audio signals. For example, the audio channel 211 receives and processes the audio component of the content generated during gameplay of the video game and forwards the processed audio signal to the channels 210 for further processing. Similarly, the video channel 212 receives and processes the video component (i.e., video signals) of the content and forwards the processed video signal to the channels 210. Inputs provided by the user using any one of the user associated input devices are received and processed using other input/output devices (I/O channel) 213 and the processed inputs are forwarded to the channels 210. The communication channels 210 also receive in-game communication from the video game executing on the console 106. The in-game communication is provided by the game logic as game content. The game content includes in-game audio content, in-game video content (game scenes, in-game images, game characters, game objects, etc.) that are used to determine current game state and to generate game scenes of the video game that are forwarded to the user for rendering at the display 111. As the user continues to play the game, the game content is dynamically updated by applying the inputs provided by the user and the updated game content is streamed to the channels 210. The channels 210 consolidates all the audio, video and the game content and forwards it to the audio shunting logic 220, which analyzes and processes the received data to determine if any audio needs to be shunted or enhanced or modified and performs the necessary modification.

In addition to the in-game content, other audio signals generated or included in communications provided by other interactive applications (i.e., non-game interactive applications) are received by the external communication channel 211, processed to separate the audio component, video component, and other components (e.g., still pictures, images, memes, GIFs, texts, etc.) and the processed content are forwarded to the audio shunting logic 220 for processing. In some implementations, the other audio signals, video signals, etc., that are part of the non-game external communications 221 captured and forwarded by the external communication channel are generated and/or shared by one or more interactive applications. For example, the non-game external communications 221 can include message content 222a generated using a messaging application, chat content 222b generated using a chat application, speech content 222c generated or captured by a speech-capturing interactive application, music content 222d that is being rendered by a music application, etc. Alternately, the external communication channel 221 can receive external communications, such as music or audio rendered in a physical environment of the user or are audio generated by one or more people, including communication from a person, conversations occurring between two or more people, audio generated by a pet or other objects in the physical environment of the user. These external communications rendered in the physical world are captured using one or more audio capturing devices and forwarded to the audio shunting logic 220 for further processing. The audio shunting logic 220 processes the various forms of external communications to retrieve the non-game audio signals.

In some implementations, the audio shunting logic 220 uses artificial intelligence (AI) to generate and continuously train an audio shunting AI model using the audio signals, game state, game context, context of non-game applications, state of the physical environment, user preferences, and data related to user behavior toward the various audio signals collected over time. The generation and training of the audio shunting AI model is done by prioritizing the different in-game and non-game audio signals received by the audio shunting logic 220, based on what is occurring within and outside of the game, including what is happening or what content is being exchanged or shared in non-game interactive applications and the physical environment associated with the non-game audio signals. The priorities can also be based on the behavior of the user in relation to the game or the interactive application, user preferences of the various audio signals, etc. The priorities assigned to the various audio signals are indicative of the relative importance of the respective audio signals to the user. Based on the assigned priorities, the audio shunting logic 220 determines whether any audio signal needs to be modified and, if so, which audio signal to maintain unmodified and which audio signal to modify (i.e., shunt/blur, enhance, convert to different frequency or volume or voice or language, delay rendering, etc.). The modified audio and the unmodified audio are forwarded to different audio channels corresponding to the different input/output devices of the user, for rendering. The different audio channels are selected based on the device settings provided by the user or the system executing the video game and/or the audio shunting logic, by the video game/interactive applications or the audio shunting logic, etc. When the audio signals are rendered, the modifications performed on a particular audio signal ensures that the appropriate audio (either the modified audio or an unmodified audio) is rendered distinctly for the user and does not conflict with the other in-game and non-game audios.

FIG. 3 shows the various sub-modules within the audio shunting logic 220 used for processing the various audio signals generated during gameplay of the video game, in some implementations. Some of the sub-modules of the audio shunting logic 220 include game context analyzer 231, communication channel input processor 232, AI priority processor 235, communication data transformer logic 240 and audio synthesizer 247. The aforementioned sub-modules are provided as mere examples and that fewer or more sub-modules may be included in the audio shunting logic 220 for processing the audio signals.

The various sub-modules of the audio shunting logic 220 are used to simultaneously process both in-game audios and non-game audios received from multiple channels, so that the different audios can be presented differently. In some implementations, a specific one of the game audio may be shunted (e.g. blurred) so that the specific audio does not conflict with another audio that is being rendered for the user. In other implementations, more than one audio may be modified (e.g., shunted/blurred, enhanced, converted). When more than one audio is modified, characteristics of a first audio may be adjusted to distinguish the first audio, characteristics of a second audio may be shunted, characteristics of a third audio may be rendered with a delayed start, for example. It is not necessary or needed to modify each and every audio that is received at a given time but is shown as a possibility that more than one audio can be adjusted at the given time so that the audio with enhanced characteristics can be distinctly heard by the user over other audios. In some cases, more than one audio may be modified (e.g., blurred or shunted) so that one or more of the unmodified audio can be distinctly heard by the user, wherein the audios that are modified can be one of the in-game audio or the non-game audio.

Conventionally, when a user is playing a video game, depending on the context and content of the video game, select ones of the in-game audio may be automatically shunted so that a specific in-game audio can be heard clearly by the user. For example, the audio generated during gameplay of the video game can include game music, audio generated by game characters, non-game characters, players interacting within the game, audio associated with an action performed within the game that may be based on the input of the user or other users playing the game with the user, etc. When a user performs an action that results in the user achieving a certain task or a certain level, the game logic recognizes the user's achievement and automatically shunts all the other in-game audios so that the audio related to the action is rendered distinctly for the user. In some cases, in addition to shunting the other audios, the game logic may enhance certain audio characteristics (e.g., frequency, volume, etc.) of the audio related to the action so that the user can experience the enhanced version of the audio. In such cases, however, when non-game audios are also being streamed to the user during gameplay and there is a time when the non-game audio needs to be distinctly rendered to the user, the user has to manually mute or shunt the in-game audio so that the user can head the non-game audio. Alternately, the non-game audio may need to be shunted in order for the user to distinctly hear one or more of the in-game audios. In this alternate case, the user will have to manually adjust the characteristics of the non-game audio to enable the user to distinctly hear the in-game audio.

In order to allow the user to enjoy both the in-game audio and the non-game audio without conflict, the audio shunting logic 220 is provided. The audio shunting logic 220 is communicatively connected to the game logic of the video game and the non-game interactive applications directly or through one or more application programming interfaces (APIs—not shown) to receive the game content and the non-game content and process both the in-game and the non-game content.

The audio shunting logic 220 receives the game content from gameplay of the game by the user and engages a game context analyzer module 231 to analyze the game content to obtain details of gameplay of the game. The audio shunting logic 220 may obtain the game content by querying the game logic of the video game or through the channels 210 (of FIG. 2). As is known, the game content includes sufficient details of gameplay of the game by the user to determine current game state and current game context. As the user continues to play the game, the audio shunting logic 220 obtains updated game content from which the game state and the game context are updated. The game context and the game state of the game are forwarded to an AI priority processor 235 as inputs.

The audio shunting logic 220 also receives non-game communication content generated and/or shared by non-game interactive applications that the user is accessing or actively participating during gameplay of the game. The non-game interactive applications can include social media applications, audio rendering/sharing applications, messaging applications, chat applications, email applications, widget applications, or any other interactive applications that can render or share audio content. In addition to the non-game communication content, the audio shunting logic 220 also receives audio generated in the physical world in the vicinity of the user. The non-game communication content from the non-game interactive applications (221 of FIG. 2) are processed by a communication channel input processor 232 to extract the audio signals, analyze the non-game communication content to determine the context and content of the non-game interactive communications. The data from the analysis and the extracted audio are forwarded to the AI priority processor 235 as communication data.

The AI priority processor 235 engages artificial intelligence to generate and train an audio shunting AI model (or simply referred to as “AI model”) with the game state and game context of the game provided by the game context analyzer 231. The training of the AI model is done by first assigning a priority to each of the different in-game audios, wherein the priority is based on game state and game context of the game. As the user continues their gameplay of the game, the game inputs provided by the user are used to dynamically update the game state and game context. The updated game state and the game context are provided to the AI priority processor 235. The AI priority processor 235 detects the changes in the game state and game context and dynamically updates the priorities assigned to the different in-game audios. Similarly, as new content is generated and/or shared by the users via the non-game interactive applications, the communication data provided to the AI priority processor 235 detailing the context and content of the non-game audios is dynamically updated to include the new content. As with the in-game audio, the AI priority processor 235 assigns priority to the different non-game audios based on what is occurring in the non-game applications and in the physical environment of the user.

In some implementations, the priorities are assigned based on game context, non-game context, preferences of the user, and the behavior of the user toward the different audios that have been collected over time. In some implementations, the priorities are assigned based on pre-defined prioritization rules 236. In some implementations, the pre-defined prioritization rules 236 may be user specified 236a or may be system defined 236b or may be a game specific 236c or combination of two or more. In some implementation, the user specified prioritization rules may be given higher precedence than the system defined and game specific rules. In alternate implementations, depending on the type of game that is being played, the game specific rules may be given higher precedence than the system defined and user specified rules. The AI priority processor 235 takes into consideration the type of game, the type and identity of user or entity providing non-game audio, the different prioritization rules and the preferences of the user to different audio content when assigning the priorities to the different audio signals. In some instances, the AI priority processor 235 may also take into consideration the behavior of the user to the different audios that were presented to further refine the priorities assigned to the different audios. For example, the priorities assigned previously to different audios may have resulted in a particular non-game audio being assigned a higher priority. As a result, the particular non-game audio may have been modified and presented to the user so as to allow the user to distinctly hear the particular audio over other audios. However, the user's prior behavior may have indicated that the user did not pay attention to the particular non-game audio. This may have been evident by the user's consistent action of manually muting the particular audio every time the particular non-game audio was presented to the user. The muting may have been done by the user as one or more characteristics of the audio may not be to the user's liking or interest or taste. For example, the audio may have been too loud (i.e., high volume) or shrill (i.e., high pitch) or may contain offensive language, etc. Consequently, the AI priority processor 235 takes into consideration the user's past behavior and the behavior during current gameplay session and refines the priority of the audios. In some implementations, the AI priority processor 235 learns from the user's past and current behavior to determine if the user's priorities have changed over time. If the user's priorities have change, the user specified prioritization rules 236a are updated to reflect the change.

The AI priority processor 235 dynamically adjusts the priorities of the different audios by continuously learning the audio preferences of the user. The AI model is generated by the AI priority processor 235 by taking as inputs the current in-game state and context, non-game state and context, user preferences, and priorities assigned to the different audios, and refined with changes to any of the inputs received from both the in-game and non-game interactive applications during gameplay. The AI model performs priority analysis to determine parts of the game that are important, type of in-game audio that is currently being presented, type of non-game audio communication that is coming in, priority of communications coming in (e.g., who is talking or communicating), to determine if an in-game audio or a non-game audio needs to be prioritized, wherein prioritizing an audio means keeping the audio unmodified or modifying the audio so that the audio can be rendered distinctly. Results of the priority analysis along with the different audios are provided as inputs to the communication data transformer logic 240.

The communication data transformer logic 240 uses the results of the priority analysis to modify a specific one of the audios. The communication data transformer logic 240 identifies audio characteristics of each audio and modifies one or more of the audio characteristics of the specific audio that is identified from the priority analysis. In some implementation, a frequency of the specific audio may be adjusted to enable the specific audio to be render at that adjusted frequency. For example, the communication data transformer logic 240 can determine a first frequency in which the specific audio is currently being rendered and adjust the frequency so that the specific audio can render at a second frequency. A frequency adjuster 241 is used to determine the current frequency of the specific audio and to adjust the frequency of the specific audio to a second frequency. The second frequency may be defined by the audio shunting logic, or specified for the user based on their preferences or aural attributes.

In another implementation, the in-game and non-game audios are broken down into multiple frequency bands. As the human ear is capable of discerning audio that fall with a particular frequency range, portions of the audio that falls outside of the particular frequency range are filtered out. A multiband compression module 242 is used to perform the multiband compression by breaking the audio signals into different frequency bands and adjust the audios by retaining the relevant frequency bands that are discernable to humans and blurring or shunting out the remaining audio. By prioritizing the audio signals that are discernable and blurring out the non-discernable frequency bands, the multiband compression module 242 is able to remove audio signals with conflicting frequencies and preserve audio signals that are relevant and important to the user. Further, the compression can be used to adjust certain ones of the audio characteristics in one or more portions of an audio so as to even out the one or more portions with the remaining portions of the audio so that the audio can be distinctly rendered.

In another implementation, instead of the frequency, a volume of the specific audio can be adjusted to make the specific audio more distinct. A volume adjuster 243 is engaged to determine the current volume of the specific audio and to adjust the volume of the specific audio. Similar to frequency adjustment, the volume adjustment may be defined by the audio shunting logic or based on user preference. In some implementations, a voice transposing may be done to a select audio so that the select audio is distinguishable over other audios. The select audio can be an in-game audio or a non-game audio and the voice transposing can be done to make the audio sound like a cartoon character or a famous character or a favorite character, for example. A voice transposing module 244 can be engaged to identify the specific audio that is identified to be transposed, based on the priority analysis, and performing voice transposing of the specific audio.

In some implementations, the specific audio identified from priority analysis can be modified so as to render in a different language. A large language module (LLM) 245 may be engaged to adjust a linguistic characteristic of the audio signal by translating the audio to a different language. The language to which the specific audio is to be translated into can be obtained from user preferences of the user, for example. In addition to translating the content of the audio to a different language, the LLM 245, in some implementation, can determine the current state of gameplay of the user and perform audio signal conversion to text for presenting to user. For example, the LLM 245 can determine, from game content analysis, that the user is involved in an intense portion of gameplay of the game and should not be interrupted. Based on this knowledge, the LLM 245 can convert the specific audio to text for rendering on a display screen of the user instead of rendering via any audio channel. In some implementations, the specific audio may be maintained in cache memory that is local to the console (i.e., computing device) 106 or available on the server of the cloud system 112 and rendered after a predefined period of time, wherein the predefined period of time may be dynamically determined from the game context (i.e., an amount of time taken to complete a task or an activity that the user is engrossed) or may be a constant period (e.g., 30 seconds, 2 minutes, etc.). For example, the specific audio may be a person talking, wherein the person is one of the social contacts that user prefers to hear from. However, when the person is talking the user may be engrossed in an intense portion of the game and does not want to be disturbed. In such a case, based on the context of the game (i.e., indicating intense portion of the game), the specific audio capturing the person talking is maintained in cache memory and presented to the user after a delay (i.e., after expiration of predefined period of time). Or, alternately, the audio is summarized in text form and presented to the user in visual format. In some implementations, when the content of the person talking is provided in a delayed fashion, the person may be provided with an informational message or some other indicator to provide a status of their audio being delivered to the recipient. For example, an informational or acknowledgement message may be sent to the person stating that the person's talk has been delivered to the user and the user is currently engrossed in some activity within the game and will respond or acknowledge at a later time. The acknowledgement message ensures that the person who is talking is not ignored but is informed in a timely manner on what the user is engaged in.

In some implementations, the conversion of audio to text and/or presentation of the text can be customized in accordance to user's preference. For example, depending on when, how and what information the user prefers to be informed about, the audio signal can be converted to text and presented at the display screen in substantial real-time or after a delayed start.

In some implementations, the communication data transformer logic 240 may adjust a temporal characteristic of the specific audio signal. In some implementations, a time shifting audio module 246 may be engaged by the communication data transformer logic 240 to adjust the temporal characteristics so that the specific audio signal can have a delayed start. In some implementations, the delayed start can be defined to be a predefined period, such that after the expiration of the predefined period, the specific audio signal is rendered to the user. In some implementations, the specific audio signal may be stored in a cache memory for the predefined period and upon expiration of the predefined period, retrieved from the cache memory and rendered to the user. In some implementations, the delayed start is performed on an audio signal upon determining that the audio signal is a non-critical audio signal. The delayed start may be defined to avoid the specific audio signal from posing a conflict to any other audio signal that is being rendered to the user. The delayed start is to ensure that the other audio signal has finished rendering prior to begin rendering the specific audio signal.

The communication data transformer logic 240 thus uses the results of the priority analysis provided by the AI priority processor 235 to identify specific audio signal that needs to be shunted/blurred, enhanced, modified, converted to text or different language, or have a delayed start, and modifies the specific audio signal by adjusting one or more of audio characteristics, temporal characteristics and/or linguistic characteristics to ensure that the specific audio signal can be rendered distinctly over other audio signals.

The specific audio signal with adjusted characteristics is forwarded to an audio synthesizer 247 for further processing. The audio synthesizer 247 receives the specific audio signal with adjusted characteristics and the native game audio (including game music, audio generated by a game character, audio generated by a non-game character, players interacting with one another, audio from an action performed in a game scene of the game, etc.) and non-game audio, and performs audio synthesis of all the audios, based on input from the communication data transformer logic 240. The synthesized audio is then sent to the different audio output channels 250 associated with the user for rendering. For example, in-game music may be forwarded to a television (TV) (e.g., 106a) and the speaker associated with the TV is used to render the in-game music, conversations between players forwarded to the headphones 105b worn by the user, non-game interactions from a chat application forwarded to the HMD 102 so that a speaker of the HMD 102 may be used to render the non-game interactions, non-game interactions of a messaging application forwarded to a mobile device 107, etc. In some implementations, the modifications to a specific audio signal may be performed at a frame level (i.e., audio frame to audio frame).

Based on the priorities assigned to the different audios directed toward the user, the audio shunting logic 220 identifies and modifies select one or more audios received from different audio sources, be it one of the in-game audio, one of the non-game audio, or a combination of both in-game and non-game audios. For example, one of the audios selected for modifying is a game audio (e.g., one of game music, audio generated by game character, audio generated by a non-game character, audio generated from the interactions between users (e.g., player of a team or spectator). The game audio was selected in response to a significant game event occurring in the game. A significant game event, for example, is defined to be a game event that elevates the user to a different level (e.g., in the game or in the play skill) or bestows special gift (e.g., a game life, a special game object, such as a magic game object, special power, etc.) or is an event that requires specific input skills or hard-to-achieve event (e.g., killing of a Boss), etc. The aforementioned description of a significant game event is provided as mere examples and should not be considered restrictive. The significant event can be specified by the game logic. The identified game audio is modified by adjusting one or more audio characteristics (e.g., frequency, volume, voice, language, etc.) so that the modified select audio can be distinctly rendered for the user over other audios. For example, during gameplay, when the user successfully kills the boss, the game logic may provide celebratory audio to indicate the user's achievement in the game. Rendering the celebratory audio may be prioritized higher over other audios so as to recognize the user's achievement and to allow the user to relish in their accomplishment within the game.

In another example, the audio characteristics of a specific messaging audio (i.e., a non-game audio received from a messaging application) may be selected and modified (i.e., audio characteristics adjusted) so that the specific messaging audio can be rendered distinctly and without conflict with the in-game audios or other non-game audios. The messaging audio may be from a social contact that the user prefers to hear and has therefore prioritized this social contact higher than other social contacts. The user preferences may be stored in a user profile and used by the audio shunting logic 220 when processing the in-game and non-game audios. Alternately, the messaging audio (i.e., non-game audio) may be an in-person communication (e.g., verbal interactions) from a social contact in the physical environment of the user that is captured using one or more microphones disposed in the computing device and/or input/output devices or in the physical environment and communicatively connected to the computing device (e.g., console) 106 in which the audio shunting logic 220 is executing. It should be noted that modification of the non-game audio (either from an interactive application or from audio source in the physical environment) is done based on the game content and context and the interactive application content and context (including activities occurring in the physical environment), in addition to the user preferences.

In order to prioritize and modify either an in-game audio or a non-game audio, the audio shunting logic 220 executing on the computing device 106 available locally in the physical environment of the user 100 or remotely on a server executing on a cloud system 112, receives the various audio signals generated during gameplay of the video game by the user. Toward this end, the audio shunting logic 220 receives the in-game audio from game logic of the video game in substantial real-time during gameplay of the video game. A game context analyzer 231 is used to analyze the game content to determine the non-game audio from one or more interactive applications, and non-game audio captured in the vicinity of the user.

Although the various implementations are discussed with respect to completing a task to satisfy the intent, wherein the task includes an event to participate, game objects or game currencies to win, certain level to achieve, an obstacle to overcome, an adversary to defeat, etc., the implementations are not restricted to such tasks but can also be extended to cover social play (i.e., social participation/social interaction). In some implementations, the social contacts or other users are tracked online. In some implementations, a heat map may be provided to identify the other users (e.g., friends, social contacts, other users with which the user has played before, etc.) who are online during the time frame specified by the user in the request. In addition to heat map, the other users expressed intentions of being online at different times can also be used to identify the other users and to fine-tune the time frame of the user with the times the other users are intending to be online so that the time frames can overlap to allow the user to have the expressed social interaction, thereby maximizing the user's gaming session. It should be noted that the various implementations described to include the games executing on a cloud game system 200 and the user accessing the video games on the cloud game system can be extended to include video games that are executed locally to the client device, wherein the local execution of the video games can be on a game console.

The user defines the kind of satisfaction (i.e., intent, such as winning a trophy, playing with friend(s)) they are seeking in a video game for a set period of time, and the session scheduler automatically goes through the gameplay activity of the user to determine which games the user has recently played, which games the user prefers to play, which games have tasks that align with the user's intent, which games have tasks that align with the users time frame (i.e., which games have tasks that are likely to be completed by the user within the specified time frame based on their gameplay skills), and use the gameplay information, storyline information, game skill information (obtained from profile data of the user) to make suggestions of video games that can be automatically instantiated to allow the user to instantly jump in and play so as to have the highest chance of completing the actions/activities to accomplish the task matching the intent within the time frame or as close to the time frame specified by the user.

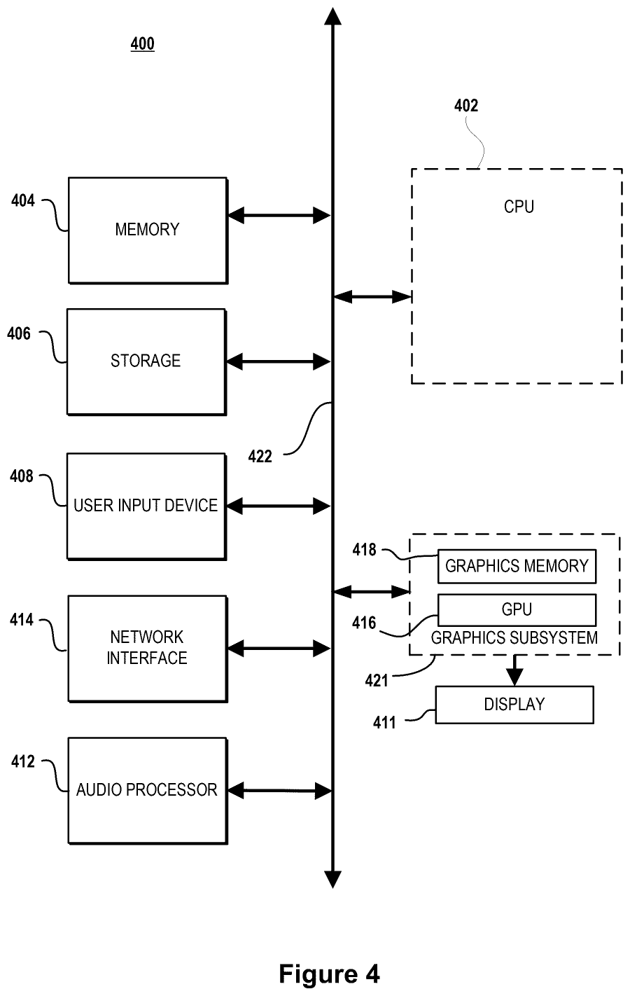

FIG. 4 illustrates components of an example device 400 (e.g., server device within cloud system 112 of FIG. 1) that can be used to perform aspects of the various embodiments of the present disclosure. This block diagram illustrates a device 400 that can incorporate or can be a personal computer, video game console, personal digital assistant, a server or other digital device, suitable for practicing an embodiment of the disclosure. Device 400 includes a central processing unit (CPU) 402 for running software applications and optionally an operating system. CPU 402 may be comprised of one or more homogeneous or heterogeneous processing cores.

For example, CPU 402 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 400 may be a localized to a player playing a game segment (e.g., game console), or remote from the player (e.g., back-end server processor), or one of many servers using virtualization in a game cloud system for remote streaming of gameplay to clients.

Memory 404 stores applications and data for use by the CPU 402. Storage 406 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 408 communicate user inputs from one or more users to device 400, examples of which may include keyboards, mice, joysticks, touch pads, touch screens, still or video recorders/cameras, tracking devices for recognizing gestures, and/or microphones. Network interface 414 allows device 400 to communicate with other computer systems via an electronic communications network, and may include wired or wireless communication over local area networks and wide area networks such as the internet. An audio processor 412 is adapted to generate analog or digital audio output from instructions and/or data provided by the CPU 402, memory 404, and/or storage 406. The components of device 400, including CPU 402, memory 404, (data) storage 406, user input devices 408, network interface 414, and audio processor 412 are connected via one or more data buses 422.

A graphics subsystem 421 is further connected with data bus 422 and the components of the device 400. The graphics subsystem 421 includes a graphics processing unit (GPU) 416 and graphics memory 418. Graphics memory 418 includes a display memory (e.g., a frame buffer) used for storing pixel data for each pixel of an output image. Graphics memory 418 can be integrated in the same device as GPU 416, connected as a separate device with GPU 416, and/or implemented within memory 404. Pixel data can be provided to graphics memory 418 directly from the CPU 402. Alternatively, CPU 402 provides the GPU 416 with data and/or instructions defining the desired output images, from which the GPU 416 generates the pixel data of one or more output images. The data and/or instructions defining the desired output images can be stored in memory 404 and/or graphics memory 418. In an embodiment, the GPU 416 includes 3D rendering capabilities for generating pixel data for output images from instructions and data defining the geometry, lighting, shading, texturing, motion, and/or camera parameters for a scene. The GPU 416 can further include one or more programmable execution units capable of executing shader programs.

The graphics subsystem 421 periodically outputs pixel data for an image from graphics memory 418 to be displayed on display device 411 (e.g., display device 111 of FIG. 2). Display device 411 can be any device capable of displaying visual information in response to a signal from the device 400, including CRT, LCD, plasma, and OLED displays. Device 400 can provide the display device 411 with an analog or digital signal, for example.

It should be noted, that access services, such as providing access to games of the current embodiments, delivered over a wide geographical area often use cloud computing.

Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services.

Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction. During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method, comprising:
retrieving in-game audio from game content generated during gameplay of a video game, the game content generated by applying game inputs provided by a user during the gameplay, the game content used to determine a current game state and current game context of the video game;
receiving non-game audio generated during the gameplay of the video game, the non-game audio received from one or more communication channels, wherein each of the in-game audio and the non-game audio includes at least one audio signal;
assigning a priority to each audio signal included in the in-game audio and the non-game audio, based on the current game context of the video game and preferences of the user, the priority used in identifying a specific one of the audio signal included in one of the in-game audio and the non-game audio that needs to be modified;
modifying a specific audio signal identified from one of the in-game audio and the non-game audio to generate a modified audio while remaining ones of the audio signals included in the in-game audio and the non-game audio are maintained as unmodified audio; and
forwarding the modified audio with the unmodified audio for rendering at one or more audio channels associated with the user, such that the modified audio is distinguishably rendered over the unmodified audio;
wherein operations of the method are performed by an audio shunting logic executing on a server computing device.

2. The method of claim 1, wherein the priority assigned to each audio signal in the in-game audio and the non-game audio changes based on changes to the game context detected during gameplay of the video game.

3. The method of claim 1, wherein the in-game audio includes audio signals associated with any one or a combination of game music, audio generated from interactions between players within a game scene, audio generated by a game character, audio generated by a non-player character, and audio generated in response to an action performed in the video game.

4. The method of claim 1, wherein modifying includes adjusting one or more characteristics of the specific audio signal to generate the modified audio, the one or more characteristics includes any one of at least audio characteristics, temporal characteristics, and linguistic characteristics.

5. The method of claim 4, wherein adjusting the audio characteristics includes adjusting at least one of frequency, volume, and voice related characteristics of the specific audio signal.

6. The method of claim 4, wherein modifying the specific audio signal includes adjusting the temporal characteristics, the adjustment to the temporal characteristics is based on the game context of the video game and is customized in accordance to preferences specified for the user.

7. The method of claim 6, wherein the adjustment to the temporal characteristics is triggered automatically by the audio shunting logic, based on the current game context of the video game.

8. The method of claim 6, wherein adjusting the temporal characteristics includes any one of,
(a) storing the specific audio signal in a cache memory and presenting the specific audio signal after a predefined period, wherein the predefined period is dynamically defined based on the current game context of the video game, and
(b) dynamically time-shifting the specific audio signal, so as to cause the specific audio signal to render with a delayed start.

9. The method of claim 4, wherein modifying the specific audio signal includes generating a summary of audio included in the specific audio signal and presenting the summary in a visual format in accordance to notification preferences specified by the user.

10. The method of claim 1, wherein modifying the specific audio signal to generate the modified audio includes changing a frequency characteristic of the specific audio signal from a first frequency to a second frequency, the second frequency is specified by the user or selected by the audio shunting logic executing on the server computing device.

11. The method of claim 1, wherein modifying the specific audio signal to generate the modified audio includes compressing the specific audio signal using an audio compressor, the audio compressor configured to identify a portion of the specific audio signal that is indiscernible and enhancing audio in the portion to make the portion of the specific audio signal discernable.

12. The method of claim 1, wherein modifying the specific audio signal to generate the modified audio includes compressing the specific audio signal using a language model compressor, the language model compressor generating the modified audio by converting the specific audio signal from a first language to a second language, wherein the second language is user-specific.

13. The method of claim 1, wherein modifying the specific audio signal further includes,
performing multiband compression on audio signals included in the in-game audio and the non-game audio, the multiband compression used to filter out audio signals in frequency bands that are indiscernible for human hearing and retain the audio signals in frequency bands that are discernible for human hearing, wherein the specific audio signal is one of the audio signals that is retained; and
modifying a frequency of the specific audio signal, so as to make the specific audio signal distinguishable from remaining ones of the audio signals that make up the unmodified audio.

14. The method of claim 1, wherein modifying the specific audio signal includes,
identifying and modifying a portion of the specific audio signal, a length of the portion identified to correspond with an event length of a significant event occurring within the video game or external to the video game.

15. The method of claim 1, wherein the specific audio signal is part of the in-game audio, and wherein assigning the priority further includes,
determining an action performed in the video game that resulted in generation of the specific audio signal that is part of the in-game audio, the action identified by analyzing the game context of the video game; and
when the action is associated with a significant event in the video game, assigning a higher priority to the specific audio signal of the in-game audio associated with the significant event and lower priorities to remaining ones of the audio signals of the in-game audio and the non-game audio, the priorities assigned to the specific audio signal and the remaining ones of the audio signals used in determining an audio signal from the in-game and non-game audio signals that is to be shunted.

16. The method of claim 1, wherein the specific audio signal is part of a non-game audio, and wherein assigning the priority further includes,
detecting the specific audio signal associated with an audio source received in the non-game audio, the specific audio signal identified based on preferences specified for the user;
assigning a higher priority to the specific audio signal received from the audio source than other audio signals included in the in-game audio and remaining ones of the non-game audio, the priorities of the specific audio signal and the remaining ones of the audio signals used in determining an audio signal from the in-game and non-game audio signals that is to be shunted.

17. The method of claim 1, wherein assigning the priority further includes,
detecting a first audio signal associated with an audio source received via one of the one or more communication channels, the audio source identified based on preferences specified for the user;
detecting an interaction related to an event that is occurring in the video game, the interaction resulting in generation of a second audio signal that is part of the in-game audio; and
assigning a first priority to the first audio signal and a second priority to the second audio signal, the first priority and the second priority assigned based on importance of the audio source to the user and significance of the event occurring in the video game, the first priority and the second priority used in determining the specific one of the first audio signal and the second audio signal for shunting.

18. The method of claim 17, wherein the first priority is defined to be greater than the second priority, when the audio source is identified to be of importance to the user, and
wherein assigning the priority causing the second audio signal to be blurred.

19. The method of claim 17, wherein the first priority is defined to be lesser than the second priority, when the event occurring in the video game is a significant event, and
wherein assigning the priority causing the first audio signal to be blurred.

20. The method of claim 1, wherein the priority is specified by the user or determined by the audio shunting logic, and
wherein the audio shunting logic is communicatively coupled to game logic of the video game through an application programming interface.

21. A system for processing audio signals received by a user during gameplay of a video game, comprising:
an audio shunting logic executing on a server of the system, the audio shunting logic configured to,
retrieve in-game audio from game content generated during gameplay of a video game, the game content generated by applying game inputs provided by a user during the gameplay, the game content used to determine a current game state and current game context of the video game;
receive non-game audio generated during gameplay of the video game, the non-game audio received from one or more communication channels, wherein each of the in-game audio and the non-game audio includes at least one audio signal;
assign a priority to each audio signal included in the in-game audio and the non-game audio, based on the current game context of the video game and preferences of the user, the priority used in identifying a specific one of the audio signal included in one of the in-game audio and the non-game audio that needs to be modified;
modify the specific one of the audio signal identified from one of the in-game audio and the non-game audio to generate a modified audio while remaining ones of the audio signals included in the in-game audio and the non-game audio are maintained as unmodified audio; and
forward the modified audio with the unmodified audio for rendering at one or more audio channels associated with the user, such that the modified audio is distinguishably rendered over the unmodified audio.
